(19) United States
(12) Patent Application Publication
(10) Pub. No.: US 2026/0145115 A1
(43) Pub. Date: May 28, 2026

(54) WATER HARVESTING DEVICE USING METAL ORGANIC FRAMEWORK

(71) Applicant: Seungbeom CHO, Seoul (KR)

(72) Inventor: Seungbeom CHO, Seoul (KR)

(21) Appl. No.: 19/279,553

(22) Filed: Jul. 24, 2025

(30) Foreign Application Priority Data
Nov. 22, 2024 (KR) 10-2024-0168350

(51) Int. Cl. B01D 53/04; B01D 53/26; B01J 20/22; B01J 20/28

(52) U.S. Cl. CPC B01D 53/0446; B01D 53/261; B01J 20/226; B01J 20/28016; B01D 2253/204; B01D 2257/80; B01D 2258/06

(57) ABSTRACT

The portable water harvesting device includes a vacuum-compatible water collection unit and a detachable lid incorporating a metal-organic framework (MOF) unit. The water collection unit comprises a vacuum pump connection port and a drain valve for extracting collected water. The detachable lid contains MOFs in the form of beads or dispersed within a porous medium, encapsulated by a vapor-permeable, MOF-retaining filter membrane. A solar-absorbing metal plate is affixed to the outer surface of the lid to facilitate thermal activation. The lid is removably attached to the collection unit via a screw-type or snap-fit closure, forming an airtight seal during vacuum desorption. Enhanced exposure of MOFs to ambient air improves water uptake, and vacuum-assisted depressurization accelerates desorption. The device is lightweight, power-independent, and suitable for deployment in off-grid or water-scarce environments such as islands, boats, or emergency lifeboats.

### CROSS-REFERENCE TO RELATED APPLICATIONS

This application claims priority to Korean Patent Application No. 10-2024-0168350, filed on Nov. 22, 2024, the entire contents of which are incorporated herein by reference.

### TECHNICAL FIELD

The present disclosure relates to a water harvesting device capable of supplying water multiple times per day without the need for any external power source.

### BACKGROUND

Water scarcity is a pressing global issue affecting both developed and developing regions. In response to this challenge, various approaches have been investigated to extract potable water from atmospheric moisture. One promising direction involves the use of porous materials with high water adsorption capacity, particularly metal-organic frameworks (MOFs), as efficient adsorbents for capturing water vapor from ambient air.

MOF-based water harvesting devices can generally be classified into two categories: passive devices and active devices. Passive devices rely solely on the natural temperature difference between day and night—typically using solar heat—to induce water adsorption and desorption. However, this approach is limited in that it typically allows for only one harvesting cycle per day. Active devices improve efficiency and cycle frequency but require external power sources, which restricts their deployment in off-grid or portable applications.

The present invention addresses these limitations by providing a water harvesting system that does not require any external electrical power yet enables multiple water harvesting cycles per day. The system utilizes the unique properties of MOFs to achieve efficient water adsorption and desorption under controlled pressure and thermal conditions.

MOFs are a class of porous crystalline materials consisting of metal clusters coordinated to organic ligands. They exhibit exceptionally high surface area and pore volume, which contribute to their outstanding water adsorption capacity. Furthermore, MOFs demonstrate distinct water adsorption and desorption behaviors that are highly responsive to temperature changes. These characteristics make MOFs well-suited as atmospheric water harvesting materials.

In a prior study by Fathieh et al. (Science Advances, 2018, 4(6), e3198), a passive water harvesting device employing the metal-organic framework MOF-801 (Zr) was reported. The device demonstrated an average productivity of 0.1 liters of water per kilogram of MOF per day in the Arizona desert, where the relative humidity was as low as 20%. However, this system was limited in that it could harvest water only once per day, making it difficult to secure an adequate supply of water on demand.

Another prior study by Hanikel et al. (ACS Central Science, 2019, 5(10), 1699-1706) described a multicyclic water harvesting system based on MOF-303(Al), which operated using an external power source. This system exhibited a significantly higher productivity of 1.3 liters per kilogram of MOF per day, but required additional energy input for heating and cooling processes.

In a further study by Li et al. (Nature Communications, 2022, 13(1), 6771), a system was developed that combined a passive water harvesting device-using MIL-101 (Cr) coated on a copper foam plate—with 24-hour thermoelectric power generation. This device achieved an improved water yield of 0.925 liters per kilogram of MOF per day. However, the system was highly complex, involving a dual-functional coating layer, a low-efficiency solar-to-electricity conversion system, and an air-cooling condenser.

As evidenced by these examples, most conventional technologies either rely solely on solar heat and thus suffer from low efficiency, or require additional external power sources, limiting their applicability in off-grid or portable scenarios.

### SUMMARY

The objective of the present invention is to provide a water harvesting device capable of supplying water multiple times per day without the need for any external power source. The water harvesting device disclosed herein is specifically designed to operate solely on solar energy, enabling its functionality in harsh or off-grid environments where electricity is unavailable. The invention further aims to improve water harvesting efficiency to ensure that a sufficient quantity of water can be collected for practical use, even under limited resource conditions.

### BRIEF DESCRIPTION OF THE DRAWINGS

FIG. 1 is a graph showing the amount of water uptake for each metal-organic framework (MOF) over an 8-hour period.

FIG. 2 is a graph showing the water uptake rate for each MOF after 8 hours.

FIG. 3 is a schematic diagram of the water harvesting device equipped with a vacuum pump according to the present invention.

FIGS. 4 and 5 are photographs showing the formation of water droplets on MIL-100(Fe) and MIL-101(Cr), respectively, under decompressed and non-decompressed conditions.

FIG. 6 is a schematic diagram of the water harvesting device according to the present invention.

### DETAILED DESCRIPTION

Hereinafter, some embodiments of the present disclosure will be described in detail with reference to the illustrative drawings. It should be noted that, when reference numerals were assigned to components in each drawing, the same reference numerals were assigned to the same components as much as possible even when they were shown in different drawings.

In addition, when the embodiments of the present disclosure are described, detailed descriptions of well-known related features or functions will not be provided when it is determined that they hinder understanding of the embodiments of the present disclosure.

According to one embodiment of the present invention, a water harvesting device is provided that includes a water harvesting unit capable of maintaining structural integrity under reduced pressure, and a detachable lid. The water harvesting unit is equipped with a vacuum pump connection port formed on the side of the unit, which allows the unit to be connected to a manual vacuum pump. A drain valve is disposed at the bottom of the water harvesting unit to discharge collected water.

The detachable lid includes a metal-organic framework (MOF) unit. The MOF unit comprises MOFs in the form of beads or in a dispersed form within a porous medium, and is encapsulated by a filter membrane. The filter membrane is composed of a material that allows the passage of water vapor but prevents the MOFs from escaping, thereby sealing the MOFs within the membrane.

The detachable lid may further include a solar-absorbing metal plate affixed to its outer surface. The solar-absorbing plate may be composed of a thermally conductive metal, such as aluminum, and may have a shape suitable for optimal solar collection—such as a flat or curved surface.

The detachable lid is configured to be easily attached to or detached from the water harvesting unit. When attached, it forms an airtight seal with the unit to maintain the internal vacuum pressure. The attachment mechanism may employ, but is not limited to, screw-type or snap-fit (Snapware-type) closures.

To enable multiple water harvesting cycles per day, the device may include two or more detachable lids with MOFs, allowing one to be recharged (adsorbing moisture from air) while the other is in use (desorbing under vacuum).

In the present invention, the MOFs may be provided in the form of beads or three-dimensionally dispersed within a porous medium.

The MOF beads may be directly synthesized in bead form, or may be formed by coating MOFs onto bead-shaped carriers. The bead-shaped carrier may be composed of a polymeric material, preferably polystyrene. To maximize surface area for water vapor contact, porous polymeric beads are preferred. In one example, polystyrene beads may be prepared and subsequently coated with MOFs to form the MOF beads. The size of the beads may vary across a broad range, for example, from 0.1 micrometers to 10,000 micrometers.

In another embodiment, the MOFs may be three-dimensionally embedded or dispersed within a porous host material. The porous medium may be, for example, porous polymers, sponge, zeolite, biochar, ceramics, metal foams, or carbon nanotubes, though it is not limited to these materials.

### Example 1: Synthesis of Metal-Organic Frameworks (MOFs)

### Synthesis of MIL-100(Fe)

0.015 g (3 mmol) of ferric chloride (FeCl₃) and 0.019 g (3 mmol) of trimesic acid (H₃BTC) were dissolved in 30 mL of N, N-dimethylformamide (DMF). The reaction solution was transferred to a Teflon-lined autoclave and thermally treated at 110° C. for 23 hours. Upon completion of the reaction, the resulting product was recovered via centrifugation and crystallization. The collected solid was washed several times with DMF and methanol, and then dried overnight at 60° C. to yield MIL-100(Fe).

### Synthesis of MIL-101(Cr)

2.007 g (5.0 mmol) of chromium nitrate nonahydrate [Cr(NO₃)₃·9H₂O] dissolved in water and 0.823 g (5.0 mmol) of terephthalic acid dissolved in DMF were sequentially added to a 100 ml beaker. To the mixture, 0.38 mL of hydrofluoric acid was added dropwise. The resulting solution was stirred continuously for 30 minutes and then transferred into a Teflon-lined autoclave, which was sealed. The autoclave was heated at 160° C. for 24 hours. After completion of the reaction, the vessel was cooled to room temperature. The product was filtered and sequentially washed with hot water and hot DMF at 65° C. for 4 hours to remove unreacted monomers and other impurities. The resulting solid was dried in a vacuum oven at 130° C. for 24 hours to yield MIL-101(Cr).

### Synthesis of MOF-801

0.2008 g of zirconium tetrachloride (ZrCl₄) was dissolved in 20 mL of DMF under magnetic stirring. Then, 46.6 μL of deionized water was added to the solution. After complete dissolution, 0.10 g of fumaric acid was added to the clear solution. The mixture was sealed in a glass vessel and placed in a preheated oven at 120° C. for 2 hours. After cooling to room temperature, the resulting white precipitate was collected via centrifugation, washed twice with DMF and once with methanol, and dried overnight at 60° C. to obtain MOF-801.

### Example 2: Evaluation of Water Adsorption Capacity of MOFs

Samples of MIL-100(Fe), MIL-101(Cr), and MOF-801, each prepared according to Example 1, were weighed out in 15 g quantities and placed in a water bath maintained at room temperature (20° C.) and 80% relative humidity (RH) for a period of 8 hours. The change in weight over time was measured to determine the water adsorption capacity of each metal-organic framework (MOF).

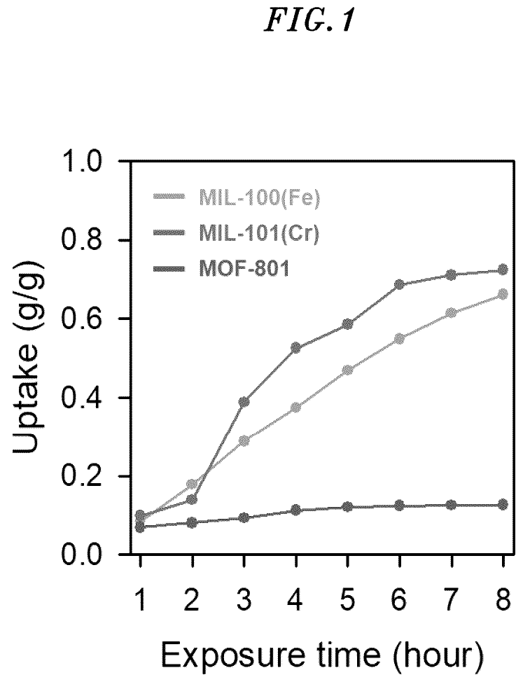

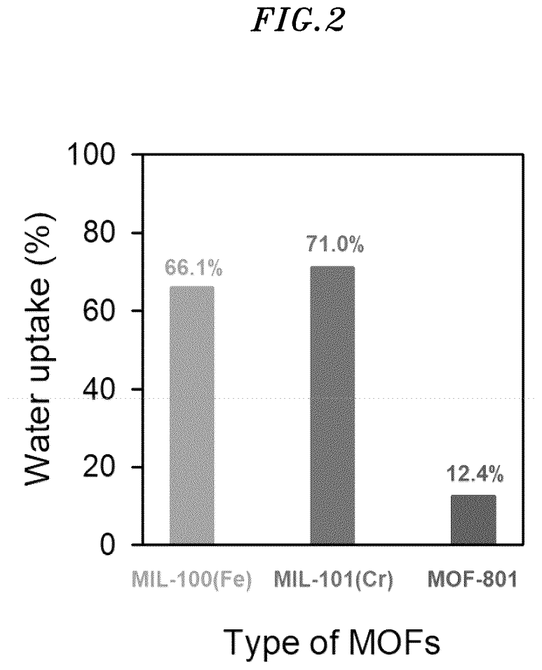

FIG. 1 illustrates the amount of water uptake (in grams) per gram of each MOF over the 8-hour period. All three MOFs showed a trend toward saturation after approximately 6 hours, with minimal additional water uptake thereafter. After 8 hours, MIL-101(Cr) exhibited the highest water uptake performance, with a 71.0 wt % increase relative to its original weight. In comparison, MIL-100(Fe) and MOF-801 showed increases of 66.1 wt % and 12.4 wt %, respectively (FIG. 2).

Although MOF-801 has been reported in prior literature to exhibit excellent water adsorption capacity in arid desert environments, it did not demonstrate sufficient water uptake under room temperature conditions in this experiment. Accordingly, no further water harvesting tests were conducted using MOF-801 in subsequent examples.

### Example 3: Verification of Water Harvesting Efficiency Using a Vacuum Pump

To evaluate the effectiveness of water harvesting under reduced pressure, an experimental apparatus was constructed. The apparatus included a metal-organic framework (MOF) container having a removable lid at the top for inserting and removing MOFs, and a side port connected to a narrow hose. The MOF container was placed inside a constant temperature chamber, which was used to maintain a controlled thermal environment.

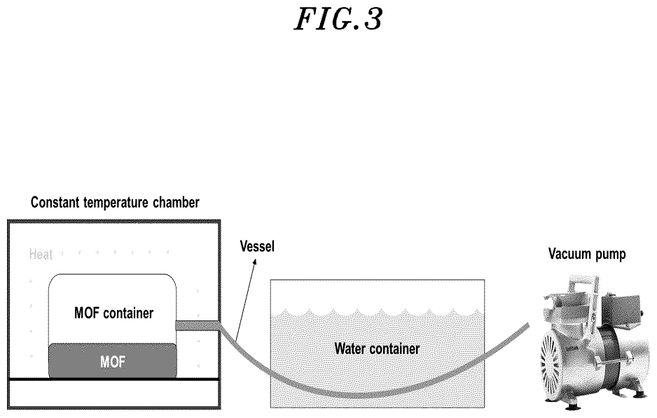

One end of the hose was connected to the MOF container, while the opposite end was connected to a vacuum pump. The middle portion of the hose—between the MOF container and the vacuum pump—was immersed in a cold water bath to maintain low temperature for condensation. A schematic diagram of the water harvesting device with vacuum pump is illustrated in FIG. 3.

For the experiment, 15 g of MOF (either MIL-100(Fe) or MIL-101(Cr)) was placed into the MOF container, the lid was sealed, and the vacuum pump was activated to reduce the internal pressure. The container was then placed inside the constant temperature chamber maintained at 40° C., and the middle portion of the hose was submerged in a water bath at 20° C.

Initially, a 5-meter-long hose was used to maximize the contact area between the vapor and the cooling surface, allowing the hose to act as a condenser. However, contrary to expectations, the increased length of the hose resulted in a larger internal volume, causing the condensed water to spread out along the hose and making it difficult to accurately quantify the collected water.

When MIL-100(Fe) was used, visible condensation droplets formed inside the hose after 12 minutes of exposure in the chamber. When MIL-101(Cr) was used, droplets were observed after 36 minutes. After 3 hours, the amount of water collected inside the hose was measured as 0.34 g for MIL- 100(Fe) and 0.71 g for MIL-101(Cr).

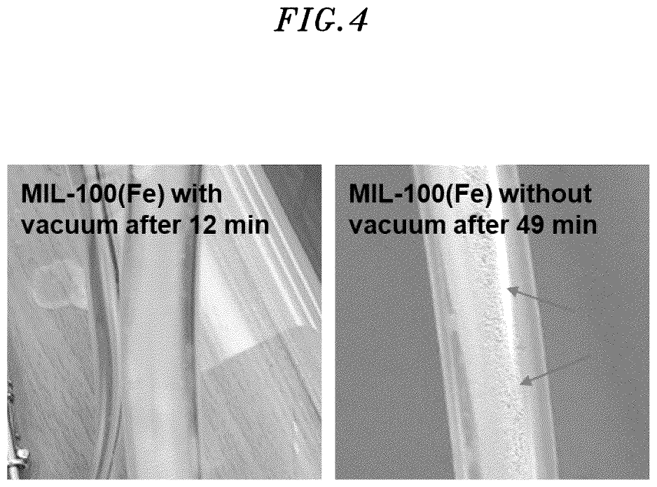

For comparison, the same procedure was repeated without applying vacuum to verify the effect of pressure reduction. 15 g of MOF was placed into the container, sealed, and placed into the 40° C. chamber, with the hose again submerged in a 20° C. water bath. In the absence of vacuum, condensation on the hose was observed after 49 minutes for MIL-100(Fe), and after 74 minutes for MIL-101(Cr), as shown in FIG. 4.

After 3 hours under non-decompressed conditions, the amount of water collected was 0.29 g for MIL-100(Fe) and 0.54 g for MIL-101(Cr).

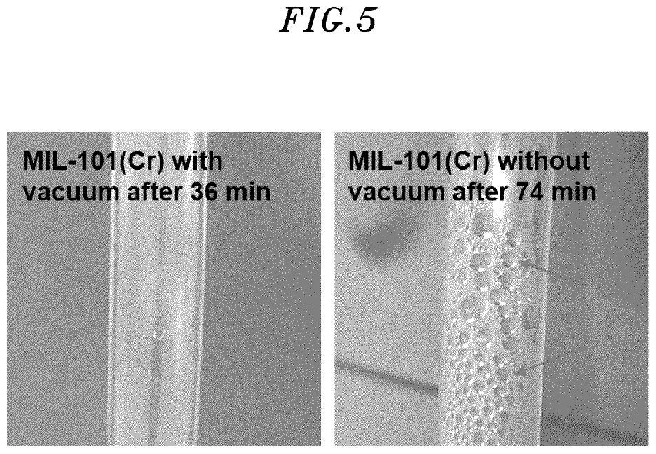

FIGS. 4 and 5 show photographic comparisons of condensation droplets formed under decompressed and non-decompressed conditions for MIL-100(Fe) and MIL-101(Cr), respectively.

### Example 4: Effect of MOF Exposure Area and Vacuum-Assisted Desorption on Water Harvesting Efficiency

In a preliminary experiment, metal-organic frameworks (MOFs) were placed inside an Erlenmeyer flask to evaluate water uptake. Even after more than 24 hours, the amount of water adsorbed by the MOFs inside the enclosed flask was minimal. This result confirmed that the exposure area of MOFs to ambient air is a critical factor in determining water uptake efficiency.

To further investigate this, the water adsorption performance of MIL-101(Cr) was evaluated under two conditions: (1) powder simply placed in a Petri dish, and (2) powder uniformly spread over a porous sponge to increase surface exposure. Both samples were placed in a water bath at room temperature (20° C., 80% RH) for 8 hours. After exposure, the sample placed in the Petri dish adsorbed 10.64 g of water, while the sample on the porous sponge showed a significantly higher uptake of 14.27 g, representing a 34% increase in water uptake due to enhanced air contact area.

In a subsequent test, MOFs were exposed to humid air for a sufficient period and then subjected to vacuum-assisted desorption. The results showed that, when using MIL-101(Cr), the water vapor trapped within the MOFs was released more than twice as fast under reduced pressure compared to atmospheric pressure. Additionally, spreading the MOFs on a sponge to increase the exposure area also resulted in a 34% increase in total water yield. Based on these findings, a prototype water harvesting device was developed that allows for multiple daily collection cycles using a removable MOF lid combined with a manual vacuum pump, significantly shortening the desorption time.

The water harvesting device of the present invention includes a water collection unit capable of maintaining its structure under vacuum conditions and a detachable lid. The side of the unit is equipped with a vacuum pump connection port, and a drain valve is installed at the bottom to discharge the harvested water. The detachable lid incorporates a MOF unit, which may include either MOFs in bead form or MOFs dispersed within a porous medium, encapsulated in a filter membrane that allows the passage of water vapor but retains the MOF particles inside.

The detachable lid may further include a solar-absorbing metal plate on its outer surface. This plate may be made of a thermally conductive material such as aluminum and may be configured in a flat or curved shape to maximize solar heat absorption. The lid is designed to be easily attached and detached from the water collection unit and, when attached, forms an airtight seal to maintain internal vacuum pressure. Suitable attachment mechanisms include, but are not limited to, screw-type or snap-fit (Snapware-type) closures. Multiple detachable lids may be provided to enable multi-cycle water harvesting within a single day.

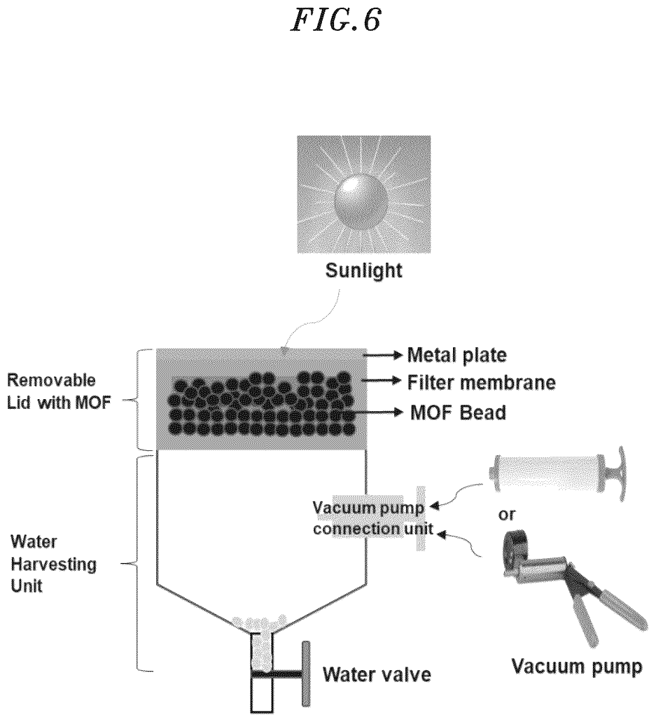

FIG. 6 shows a schematic diagram of the water harvesting device according to the present invention.

This device demonstrates that efficient water harvesting can be achieved through the combination of MOFs and vacuum-assisted desorption. By overcoming the limitations of conventional passive and active systems, the invention enables multiple harvesting cycles without the need for external power. By increasing MOF exposure area and employing a removable lid, the adsorption-desorption process is significantly optimized.

Future improvements in MOF materials with higher water uptake capacity and device configurations that enable greater temperature differentials are expected to further enhance performance. Additionally, by diversifying MOF types, the device can be adapted to a range of humidity conditions. Scaling up the system could make it suitable for deployment in water-scarce regions, while miniaturization and portability would allow use in islands, boats, and lifeboats, where access to fresh water is limited.

This study confirms the feasibility of a scalable and sustainable water harvesting technology and suggests its potential to contribute to global solutions for worsening water scarcity.

The present disclosure is not necessarily limited to the above-mentioned embodiments. That is, one or more of the components may be selectively combined to operate within the scope of the purpose of the present disclosure.

In addition, unless defined otherwise, all terms used herein, including technical or scientific terms, have a meaning consistent with the meaning commonly understood by a person having ordinary skills in the technical field to which the present disclosure belongs. Commonly used terms such as terms defined in dictionaries should be interpreted as having meanings consistent with the meanings in the context of the related technology, and should not be construed in an ideal or overly formal sense unless explicitly defined in the present disclosure.

The description above is only an exemplary description of the technology of the present disclosure, and various modifications and changes within the scope of the essential characteristics of the present disclosure will be possible to a person having ordinary skill in the technical field to which the present disclosure belongs. Therefore, the embodiments disclosed in the present disclosure are not intended to limit the technology of the present disclosure, but to explain them, and the scope of the technology of the present disclosure is not limited by the embodiments. The scope of the present disclosure should be determined based on the following claims, and all technologies within the scope equivalent thereto should be deemed to be included in the scope of the present disclosure.

1. A water harvester harvesting device comprising:
a water collector collection unit configured to maintain its structural integrity under reduced pressure;
a detachable lid coupled to the water collector collection unit;
wherein the water collector collection unit comprises:
a vacuum pump connector port formed on a lateral side of the water collector unit and configured to connect to a vacuum pump; and
a drain valve disposed at a lower portion of the water collector unit for discharging harvested water;
wherein the detachable lid comprises:
a metal-organic framework (MOF) assembly unit;
a solar-absorbing metal plate attached to an outer surface of the lid, the plate being flat or curved in shape;
an attachment coupler mechanism configured to removably secure the lid to the water collector collection unit using a screw-type or snap-fit closure;
wherein the MOF assembly unit comprises:
MOFs in the form of beads or MOFs dispersed within a porous medium; and
a filter membrane enclosing the MOFs, the filter membrane being configured to permit passage of water vapor while preventing the MOFs from escaping;
wherein the MOF beads are formed by coating the surface of bead-shaped substrates with MOFs,
wherein the bead-shaped substrate comprises a porous polymer material, and
wherein the porous medium is selected from the group consisting of sponge, zeolite, biochar, ceramic, metal foam, and carbon nanotubes.

2. The water harvester harvesting device of claim 1,
wherein the metal-organic framework (MOF) is MIL-100(Fe) or MIL-101(Cr), and
wherein the porous polymer material is polystyrene.

3-10. (canceled)
